(19) United States
(12) Patent Application Publication
(10) Pub. No.: US 2017/0136791 A1
(43) Pub. Date: May 18, 2017

(54) MOBILE TYPE PRINTER AND PRINTING METHOD THEREOF

(71) Applicant: ZHEJIANG UNIVERSITY OF TECHNOLOGY, HANGZHOU, Zhejiang Province (CN)

(72) Inventor: HONGWU ZHAN, HANGZHOU, ZHEJIANG PROVINCE (CN)

(21) Appl. No.: 15/323,364

(22) PCT Filed: Jul. 8, 2014
(86) PCT No.: PCT/CN2014/081830

§ 371 Date: Dec. 30, 2016

(51) Int. Cl. B41J 23/32; B41J 29/02

(52) U.S. Cl. CPC B41J 23/32; B41J 29/02

(57) ABSTRACT

A mobile type printer and a printing method thereof are disclosed. The mobile type printer comprises a rack. The rack is equipped with a power source, a motor, a mobile device, an ink-jet printing head and a central processing unit, wherein the central processing unit comprises a mobile control unit and a printing control unit; the entire rack is moved by the mobile device to an appropriate place according to an instruction issued by the mobile control unit, ink-jet printing is conducted by the ink-jet printing head according to an instruction issued by the printing control unit; the mobile device comprises two coaxial action wheels; and the ink-jet printing head is arranged at one side of a rotation shaft, and the power source and the motor are arranged at the other side of the rotation shaft. The mobile type printer, departing from a traditional structure of a width-fixed printer, cannot only freely move on a printing medium, but also can print an image-text in any size.

### TECHNICAL FIELD

The present invention relates to a printer and a printing method thereof, and more particularly, to a mobile type printer and a printing method thereof.

### BACKGROUND ART

Currently, ink-jet printers are in two conventional structures. One structure is a scanning type structure in both domestic and commercial fields, a piece of paper enters into or deviates from a printing area under a dynamic traction, and a printing head is installed in a track perpendicular to a motion direction of the paper to conduct scanning and printing in reciprocating type along the track. In this way, a width of the printing paper may be limited by a length of the track. In order to accurately track a printing position, both the paper and the printing head are driven by using a motor (e.g., a stepping motor or the like) having an accurately positioning capability respectively, or using a grating or magnetic grid position encoder or the like to detect a feeding distance of the paper.

The other structure is called as a one-way printing structure, which is commonly used in the field of industrial printing. A printing head having a large width is used, or a plurality of printing heads are combined together to form a printing head set having a large width. The paper passes through below the printing head under a dynamic traction, and ink-jet output is conducted by the printing head to complete printing. The printable maximum paper width is limited by a width and a structure design of the printing head. A printing position is determined by a rotation angle of the stepping motor, or determined by detecting the feeding distance of the paper by the grating or magnetic grid position encoder or the like.

The stepping motor is a control motor which can convert an electric pulse signal into an angular displacement to output. By the conversion of mechanical transmission, the angular displacement is easy to be transformed into a displacement in a linear direction. Therefore, the stepping motor can be used for controlling an accurate feeding distance of the paper.

A rotary type position encoder mainly includes a grating position encoder and a magnetic grid position encoder, which is a sensor that can detect a change in the angular displacement and convert it into an electrical signal to output. The rotary type position encoder generally has two assemblies, one of which is a grating engraved with alternated light and dark stripes or a magnetic grid filled with alternated N pole/S pole magnetic field, and the other of which is a photoelectric conversion member used to recognize the grating stripes or a magnetic-electric conversion member used to recognize and read the change in the magnetic field. When the rotary type position encoder is used in general, a ring-shaped grating or magnetic grating in the rotary type position coder is fixed on a rotation shaft, and then an angular displacement of a motion shaft is detected by a photoelectric or magneto-electric conversion member.

For a traditional printer, an input shaft of the rotary type position encoder is also connected with a rubber wheel, so that a paper contacted with the rubber wheel is tangent to a motion direction of the paper. In this way, a linear motion distance of the paper is obtained by detecting a spiral motion angle of the rubber wheel.

A printer in a traditional structure is neither freely printed at a large size due to limitation to a structure size; nor has a portable performance, which limit requirements for mobile office of people and for flexibly using the printer.

### SUMMARY OF THE INVENTION

In order to solve the problems that a printer in the prior art cannot realize free printing and has no portability, the present invention provides a mobile type printer which is capable of moving freely on a printing medium and having the capability of printing a large-sized image-text; and such mobile type printer can be made in a compact dimension, and thus easy to carry, which is conducive to mobile office.

In order to achieve the above objects, the present invention is embodied by the following technical solutions:

A mobile type printer comprises a rack, wherein the rack is equipped with a power source, a motor, a mobile device, an ink-jet printing head and a central processing unit, wherein the central processing unit comprises a mobile control unit and a printing control unit; the entire rack is moved by the mobile device to an appropriate place according to an instruction issued by the mobile control unit, ink-jet printing is conducted by the ink-jet printing head according to an instruction issued by the printing control unit; the mobile device comprises two coaxial action wheels connecting with the motor and installed below a middle portion of the rack along a same rotation axis in parallel; and the ink-jet printing head is arranged at one side of the rotation axis, and the power source and the motor are arranged at the other side of the rotation axis.

For the abovementioned mobile type printer, the motor is a stepping motor.

For the abovementioned mobile type printer, the mobile device further comprises a sensor group, parameters sensed are input by the sensor group into the central processing unit; a rack moving path and an ink-jet position of the printing head are stored in the central processing unit; compared with the parameters input by the sensor group, when the rack is discovered to move to a preset position, the sensor group is communicated with the printing control unit, to issue an ink-jet printing instruction.

For the abovementioned mobile type printer, the sensor group further comprises an angular velocity sensor and an acceleration sensor, when the rack moves, parameters detected by the angular velocity sensor and the acceleration sensor are input into the central processing unit, to enable the central processing unit to get hold of a moving posture of a printing device, and compared with a preset moving path, the action wheel is driven to rotate by the driving motor of the mobile control unit, to maintain the moving posture of the printer, so that the printer moves on a preset moving path.

The abovementioned mobile type printer, the sensor group comprises a photoelectric distance sensor.

For the abovementioned mobile type printer, the photoelectric distance sensor is a photoelectric mouse sensor, a light emitting diode is installed below the rack, a lens group is installed below the light emitting diode, the photoelectric mouse sensor is installed above the lens group to receive a reflected light, and a sensor signal is accessed into the mobile control unit through an interface microprocessor.

For the abovementioned mobile type printer, the photoelectric distance sensor is a laser mouse sensor, a luminous tube is installed below the rack, a lens group is installed below the luminous tube, the laser mouse sensor is installed above the lens group to receive a reflected light, and a sensor signal is accessed into the mobile control unit through an interface microprocessor.

For the abovementioned mobile type printer, the sensor group comprises a rotary type position encoder, and the rotary type position encoder and the rotation shaft of the motor or the action wheel are coaxially installed.

For the abovementioned mobile type printer, the sensor group comprises a rotary type position encoder, movable oscillating arms are installed in the racks at both sides of the action wheel through a pendulum shaft, a driven wheel is installed at a terminal of the movable oscillating arm, and the rotary type position encoder and the rotation shaft of the driven shaft are coaxially installed.

A printing method comprises the following steps of horizontally placing a medium to be printed, placing the mobile type printer according to any one of claims 1 to 7 on the medium to be printed, presetting a plurality of rack moving path and ink-jet position of the printing head in the central processing unit of the mobile type printer, moving the printer by the mobile device on the medium to be printed according to the preset route, and printing by the printing head according to the preset ink-jet position.

For the abovementioned printing method, prior to starting printing, the mobile type printer is kept in a sloping status under the effect of gravity thereof, an outside of the rack and two action wheels are contacted with the medium to be printed in a manner of three-point contact; when starting printing, the mobile control unit drives the action wheels to rotate, so that the printer starts moving at a certain accelerated velocity in a direction along which the rack is not contacted with the medium, when a center of gravity of the printer is lower than an axis of the two action wheels, the outside of the rack automatically separates from the printing medium, to complete a starting process.

For the abovementioned printing method, prior to starting printing, the mobile type printer is kept in a sloping status under the effect of gravity thereof, an outside of the rack and two action wheels are contacted with the medium to be printed in a manner of three-point contact; when starting printing, the mobile control unit drives the action wheels to rotate, so that the printer starts moving at a certain accelerated velocity in a direction along which the rack is not contacted with the medium, when a center of gravity of the printer is higher than an axis of the two action wheels, the mobile control unit further needs to drive the action wheels to brake to slow down, so that the printer has a reverse accelerated velocity, and the outside of the rack automatically separates from the printing medium, to complete a starting process.

The mobile type printer, departing from a traditional structure of a width-fixed printer, can freely move on a printing medium, and then can print an image-text in any size.

Main components of the printer are an ink-jet printing head and a battery power source, so that the printer can be designed to be very small, and thus is convenient for a user to carry, and has a well portable performance of mobile office.

Two control wheels are used to keep the printer in a balanced position industriously, ensuring that the rack never comes into contact with the printing medium while printing by the printer, and keeping a line of gravity tending to vertically pass through the rotation shaft of the action wheel. To achieve this goal: when the center of gravity of the printer is higher than the axis of the two action wheels, and an angular velocity sensor detects a backward-sloping rate of the printer is increased or tends to increase, a backward accelerated velocity is outputted by driving the action wheel to amend; when an angular velocity sensor detects a forward-sloping rate of the printer is increased or tends to increase, a forward accelerated velocity is output by driving the action wheel to amend; when the center of gravity of the printer is lower than the axis of the two action wheels, and an angular velocity sensor detects a backward-sloping rate of the printer is increased or tends to increase, a forward accelerated velocity is outputted by driving the action wheel to amend; when an angular velocity sensor detects a forward-sloping rate of the printer is increased or tends to increase, a backward accelerated velocity is output by driving the action wheel to amend.

The printer, driven by two wheels, can efficiently and freely move in a self-balanced mode, so that the member has a lower cost and is even more flexibly controlled. A typical working velocity of the ordinary ink-jet printing head is around 1 meter/second. When an actual motion velocity of the printing head is lower than the value, the performance of the printing head is not exerted fully. The two-wheel-driven structure is more easily to reach the velocity, so that the printing head can work at an extremely high velocity. For the traditional rack-type printer having a fixed width, to enable the printing head at a maximum working velocity, the rack has to be made very long, or a power and a torque of the driving motor have to be very high, to meet requirements of acceleration and deceleration of the printer. By comparison of the two, the portable performance of the present invention is very good.

Two action wheels are controlled by detecting the angular velocity and accelerated velocity of the printer, the posture balance and free motion of the printer may be achieved. Printer starts without manual intervention, but is put on the print medium to complete printing through a communication instruction. This way is efficient and convenient, is favorable to improve the entire printing velocity, and provides good operation means.

In addition, a turning direction and a rotation velocity of the two action wheels are controlled respectively, so that a relative velocity difference occurs between the two wheels, thereby being capable of enabling the printer to move in a straight line or a curve along a preset track, to flexibly and efficiently print patterns, graphics and texts.

Currently, the photoelectric distance sensor is divided into a photoelectric mouse sensor and a laser mouse sensor.

In case that the photoelectric mouse sensor is used, and when a light emitted by a light emitting diode is irradiated to the surface of the medium to be printed through a lens, the roughness of a surface to be printed will produce a feature shadow, the reflected light with the feature shadow information will be irradiated to the photoelectric mouse sensor through a lens assembly, and an image received is imaged by a built-in micro-imager of the photoelectric mouse sensor.

In case that the laser mouse sensor is used, and when a coherent light emitted by a laser tube is irradiated to a surface to be printed by a lens, a reflected light will coherently diffract, and diffraction stripes will be irradiated onto the laser mouse sensor through a lens group, and an image received is imaged by a built-in micro-imager of the laser mouse sensor.

Thus, when the printer is translated on the surface of the printing medium, its trajectory is recorded by the photoelectric distance sensor as a set of coherent images taken at a high velocity and a relative motion distance between the printer and the surface of the printing medium is calculated according to feature points having varied shadows and carried by the reflected light.

This photoelectric distance sensing technology is used in a commonly used mouse. This photoelectric distance sensor is different from the photoelectric encoder commonly used in the traditional printer, and can determine a motion distance of the medium in a bi-dimensional plane in a noncontact mode in the meanwhile, with a resolution ratio of up to 5000-dot or even 6000-dot pixel per inch. Moreover, both the photoelectric mouse sensor and the laser mouse sensor are low-price and widely-used photoelectric distance sensor currently.

The high-precision photoelectric distance sensor can be used for accurately obtaining the motion distance of the printer, which can better control the motion of the printer.

The action wheel is directly driven by the stepping motor, and the rotation angle of the action wheel may also be obtained, so as to obtain the motion position of the printer.

Similarly, installing the rotary type position encoder in any rotation shaft of the mobile device of the printer is also a method for obtaining the motion position of the printer. The rotary type position encoder cannot only be installed on the rotation shaft of the action wheel, but also can be installed on the output shaft of the driving motor of the action wheel, or even can be installed on a transmission chain of the driving motor and the action wheel.

Another method for installing the rotary type position encoder is to realize by oscillating arms at both sides of the action wheel and driven installed thereon. The rotary type position encoder and the driven wheel are installed coaxially. Due to the action of gravity of the driven wheel and the oscillating arm, the driven wheel is in frictional contact with the surface of the printing medium. The position changing information of the printer in the motion process can also be obtained by the rotary type position encoder coaxially installed with the driven shaft in the meanwhile.

The printer is placed on the surface of the printing medium, and stops sprinting, it is in a naturally sloping status due the action of gravity. An outside of the rack and two action wheels are contacted with the medium to be printed in a manner of three-point contact.

When the center of gravity of the printer is lower than the axis of the two action wheels, and when the printer starts printing, the printer starts moving at a certain accelerated velocity in a direction along which the rack is not contacted with the medium, and the outside of the rack automatically separates from the printing medium, to complete a starting process.

When a center of gravity of the printer is higher than an axis of the two action wheels, the printer starts moving at a certain accelerated velocity in a direction along which the rack is not contacted with the medium, the mobile control unit further needs to drive the action wheels to brake to slow down, so that the printer has a reverse accelerated velocity, and the outside of the rack automatically separates from the printing medium, to complete a starting process.

By using the mobile type printer, free printing can be completed as long as the printer is driven to move along the preset path and the ink-jet printing head is instructed to jet ink on a preset ink-jet position. Compared with a traditional scanning type, one-way printing method, this printing method has a higher printing degree of freedom, a higher printing efficiency, and a faster printing velocity.

### BRIEF DESCRIPTION OF THE DRAWINGS

FIG. 1 is a schematic diagram of an entire structure of the present invention.

FIG. 2 is a schematic structural diagram of a rotary type position encoder installed on a motor.

FIG. 3 is a schematic structural diagram of a rotary type position encoder installed on a rotation shaft of an action wheel.

FIG. 4 is a schematic structural diagram of a rotary type position encoder installed on an oscillating arm.

FIG. 5 is a schematic diagram of a photoelectric distance sensor of the present invention.

FIG. 6 is a schematic structural diagram of a photoelectric distance sensor and a lens group of the present invention.

FIG. 7 is a schematic diagram of a stop status of a printer when a center of gravity of the printer is above a rotation axis.

FIG. 8 is a schematic diagram of a working status of a printer when a center of gravity of the printer is above a rotation axis.

FIG. 9 is a schematic diagram of a stop status of a printer when a center of gravity of the printer is below a rotation axis.

FIG. 10 is a schematic diagram of a working status of a printer when a center of gravity of the printer is below a rotation axis.

FIG. 11 is a flow chart of connecting a printer through a Bluetooth interface according to the present invention.

FIG. 12 is a flow chart of connecting a printer through an interface according to the present invention.

FIG. 13 is a flow chart of connecting a printer through a Bluetooth and combination according to the present invention.

FIG. 14 is an operation flow chart of the printer of the present invention.

FIG. 15 is a framework of the printer of the present invention.

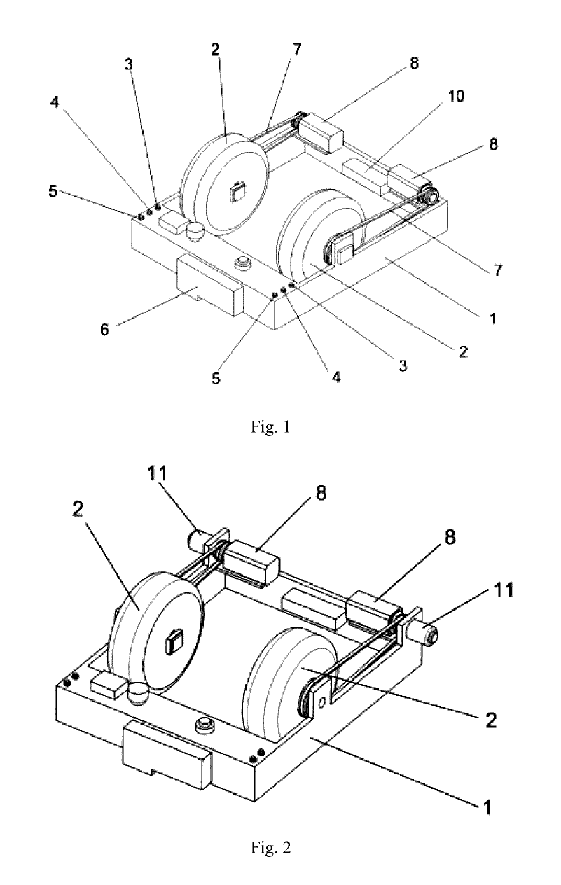

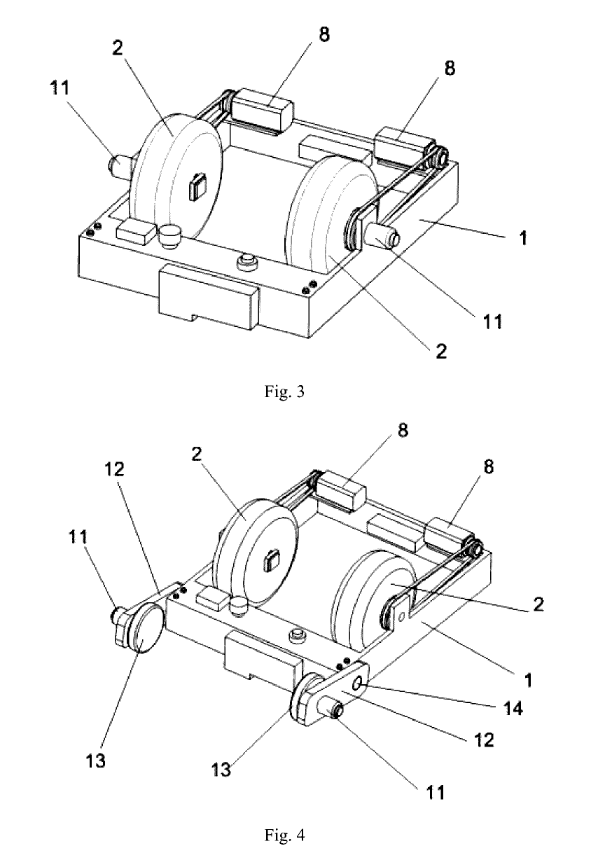

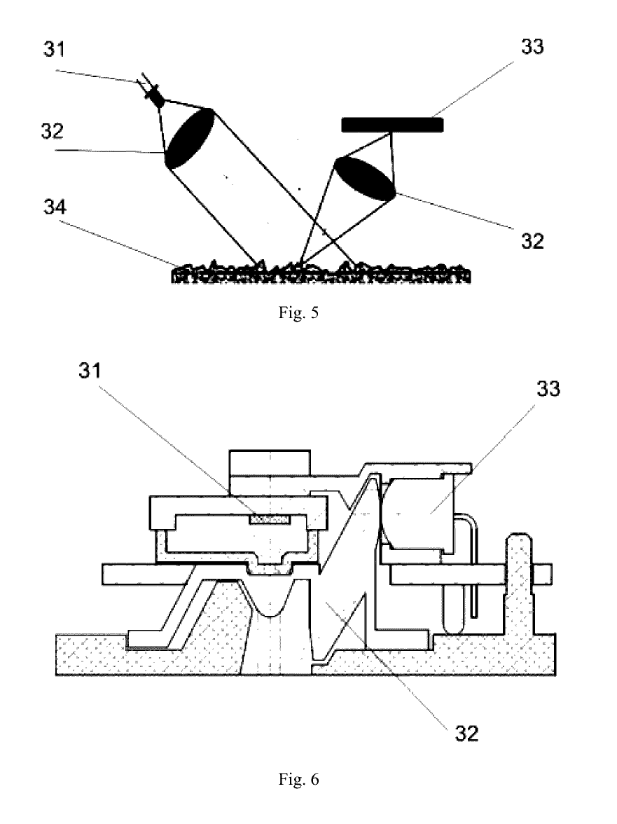

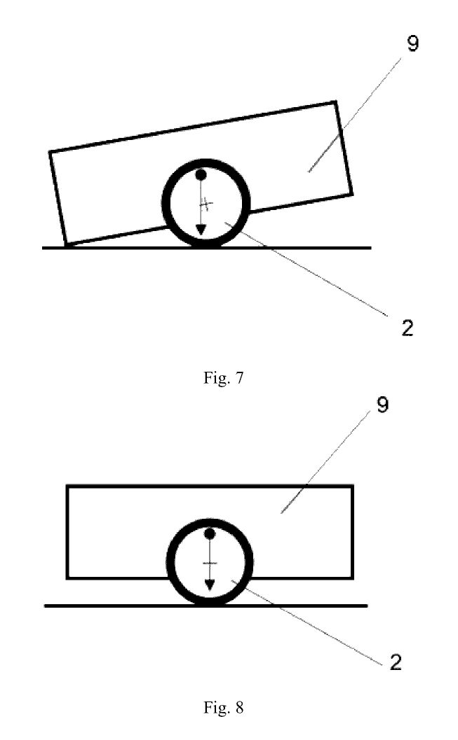

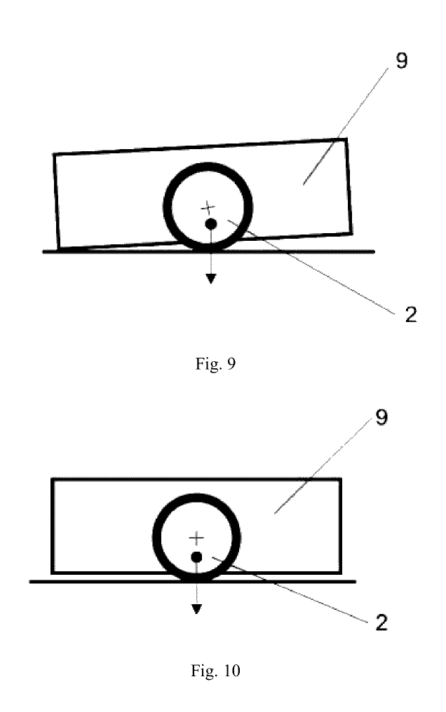

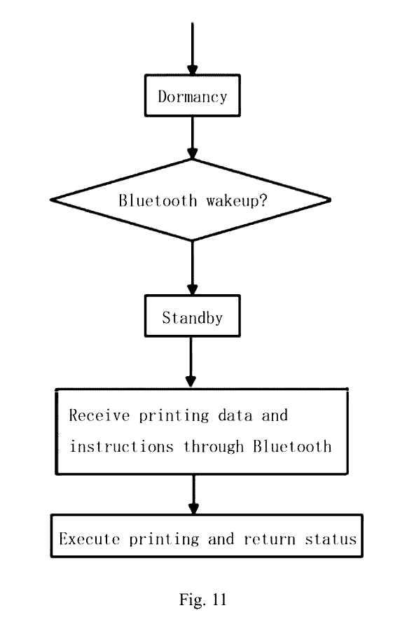

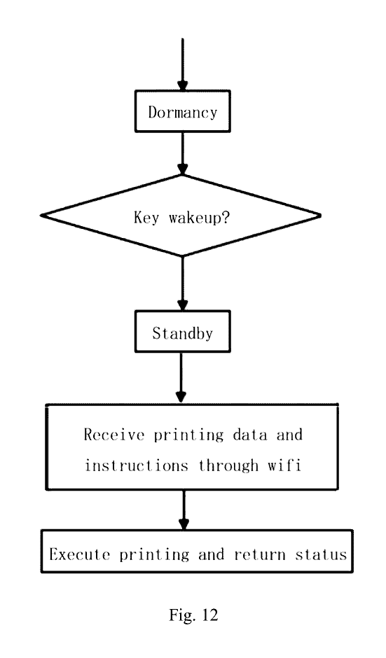

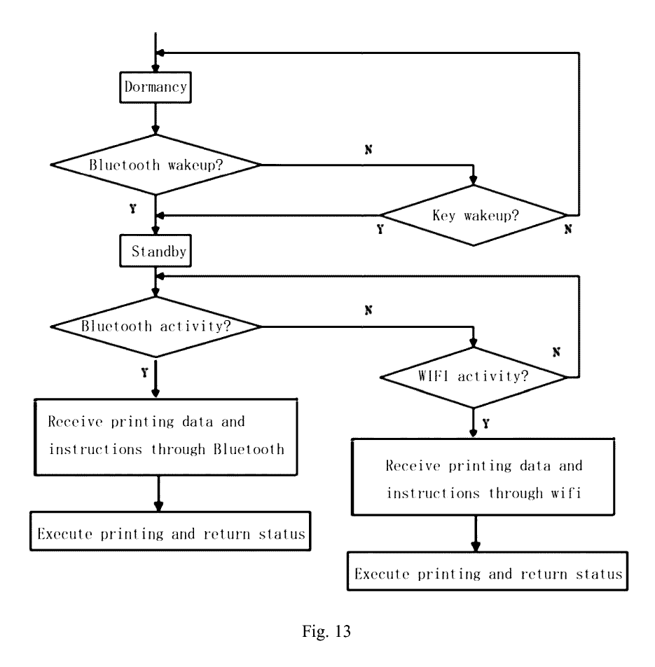

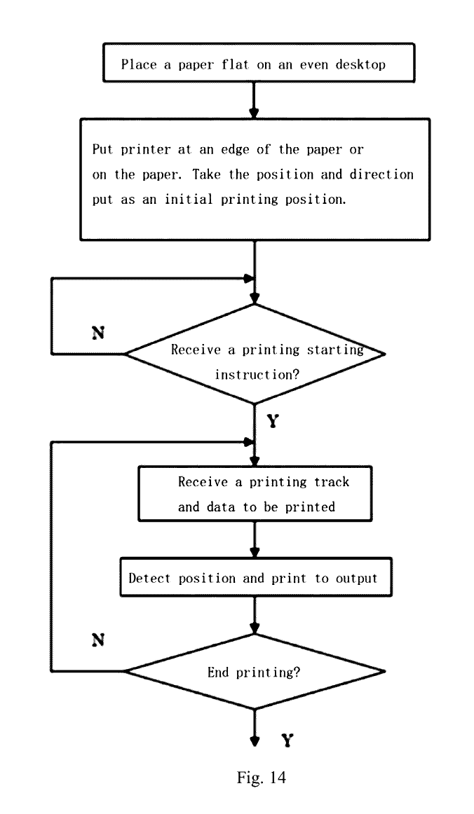

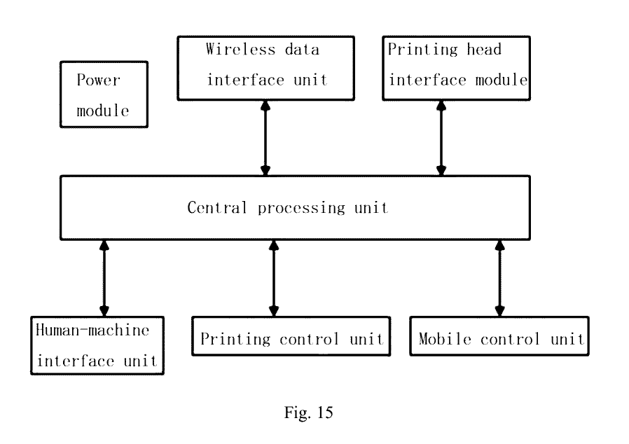

Reference numerals in the figure: 1 refers to rack, 2 refers to action wheel, 3 refers to photoelectric distance sensor, 31 refers to light emitting diode, 32 refers to lens group, 33 refers to signal receiving end of photoelectric sensor, 34 refers to roughened surface of printing medium, 4 refers to acceleration sensor, 5 refers to angular velocity sensor, 6 refers to ink-jet printing head, 7 refers to transmission chain for connecting action wheel and motor, 8 refers to driving motor of action wheel, 9 refers to mobile type printer, 10 refers to battery, 11 refers to rotary type position encoder, 12 refers to oscillating arm, 13 refers to driven wheel, and 14 refers to pendulum shaft.

### DETAILED DESCRIPTIONS OF THE PREFERRED EMBODIMENTS

### Embodiment I

A mobile type printer comprises a rack 1, wherein the rack is equipped with a battery 10, a motor 8, a mobile device, an ink-jet printing head 6, and a central processing unit. The central processing unit comprises a mobile control unit and a printing control unit; the entire rack is moved by the mobile device to an appropriate place according to an instruction issued by the mobile control unit, and ink-jet printing is conducted by the ink-jet printing head according to an instruction issued by the printing control unit.

The ink-jet printing head is installed at one side of the rack, two action wheels 2 are installed below a middle portion of the rack along the same rotation axis in parallel; while a power source, a motor, a control device and other accessories are installed at the other side of the rotation axis, the weight of the printing head and the weight of the other accessories are fundamentally balanced by taking an axis of the action wheel as a center of symmetry, and the action wheels are connected with the motor through a transmission chain.

A sensor group of the mobile control unit comprises a photoelectric mouse sensor 3. The sensor is installed on the rack, and a light emitting diode 31 and a lens group 32 is installed below the rack. The light emitting diode faces downwards to irradiate a light to a surface as required to be printed through the lens group, the signal receiving end 33 of the photoelectric mouse sensor is installed above the lens group for receiving a reflected light of the surface of the printing medium, and a signal of the photoelectric mouse sensor is accessed to the central processing unit.

The sensor group of the mobile control unit further comprises an angular velocity sensor and an acceleration sensor 4. When the rack moves, parameters detected by the angular velocity sensor and the acceleration sensor are input into the central processing unit, to enable the central processing unit to get hold of a moving posture of a printing device, and compared with a preset moving path, the action wheel is driven to rotate by the driving motor of the mobile control unit, to maintain the moving posture of the printer, so that the printer moves on the preset moving path.

The moving path of the printer and the ink-jet position of the printing head are stored in a memory of the central processing unit, the built-in moving path and ink-jet position are compared with the parameters input by the sensor group of the mobile control unit, the central processing unit is communicated with the printing control unit to issue an instruction of ink-jet printing to the ink-jet printing head through the printing control unit after the printer is discovered to move to a preset ink-jet position.

When used, the printer is firstly placed horizontally on the surface of the printing medium. At this moment, the printer is in a stop status. The rack of the printer is in a sloping status along the rotation axis of the action wheel due to the action of gravity. At this moment, one side of the rack and two action wheels are contacted with the surface of the medium to be printed in a manner three-point contact, wherein a contact point between the rack of the printer and the printing medium is located at one side of the rotation axis of the two action wheels, and the center of gravity of the printer and the action wheel are not on a perpendicular line. The center of gravity of the printer can be either above the axis of the action wheel or below the axis of the action wheel.

When starting printing, the mobile control unit drives the action wheels to rotate, so that the printer starts moving at a certain accelerated speed in a direction along which the rack is not contacted with the medium, when a center of gravity of the printer is lower than an axis of the two action wheels, the outside of the rack automatically separates from the printing medium, to complete a starting process; when a center of gravity of the printer is higher than an axis of the two action wheels, the mobile control unit further needs to drive the action wheels to brake to slow down, so that the printer has a reverse accelerated speed, and the outside of the rack automatically separates from the printing medium, to complete a starting process.

After an action posture of the printer starts, that it to say, the action wheel can be driven to rotate, so that the printer moves on the printing medium. When the printer moves to the preset ink-jet position, the printing head can be instructed to conduct ink-jet printing.

The printer is equipped with a simple human-machine interface unit, comprising a battery status indicator lamp, a working status indicator lamp, and a function key. The printer is equipped with an LED indicator lamp to display a battery capacity, starting-up/printing/standby/dormancy, wireless connection and other status information according to turning-on, turning-off, and programmable special flashing rules.

The status of the battery status indicator lamp and the corresponding information are shown in the following table.

| | |
|---|---|
| Normally turn on | Reminder that the remaining capacity of a |
| | battery is higher than 90%, or charging is |
| | complete. |
| Turn on 0.5 s, turn off 0.5 s, | Reminder that charging is in progress. |
| and flash continuously | |
| Normally turn off | Reminder a dormant status, or that the |
| | battery is exhausted. |
| Turn on 1 s, turn off 1 s, | Reminder the remaining capacity of the |
| and flash continuously | batter is at a normal level, which is higher |
| | than 20% but less than 90%. |
| Turn on 0.5 s, turn off 1 s, | Reminder that the remaining capacity of |
| and flash continuously | the battery is lower than 20%. |

The status of the working status indicator lamp and the corresponding information are shown in the following table.

| | |
|---|---|
| Normally turn off | Reminder that the printer is in a dormant |
| | status. |
| Normally turn on | Reminder that the printer is in a standby |
| | status and can accept a printing task. |
| Turn on 0.5 s, turn off 1 s, | Reminder that a mechanism, a hardware |
| and flash continuously | circuit, or an ink box of the printer is |
| | abnormal. |
| Turn on 0.5 s, turn off 0.5 s, | Reminder that a printing task is wrong. |
| and flash continuously | |
| Turn on 0.3 s, turn off 0.3 s, | Reminder that a wireless communication |
| and flash continuously | activity is receiving printing data or |
| | instructions. |
| Turn on 1 s, turn off 1 s, and | Reminder that the printer is printing. |
| flash continuously | |

An operation method of the function key is shown in the following table.

| | |
|---|---|
| Single-Click | Enable the printer to exit the dormant |
| | status. |
| Double-click | Reset the printer, delete the abnormal |
| | information, and cancel the unfinished |
| | printing task. |
| Double-click-hold for more | Enable the printer to enter a configuration |
| than 2 s | mode, and be able to access internal |
| | maintenance instructions. |
| Double-click-hold for more | Enable the printer to enter a Bluetooth |
| than 2 s | pairing mode. |
| Single-Click-double-click | Disconnect the printer and research to |
| | connect a WIFI. |

In the meanwhile, the printer can also be connected with a wireless data interface unit, having a Bluetooth slave interface and a WIFI interface. Intelligent devices that control the operation of the printer can be ordinary desktop computers, portable laptops, tablets, and smart phones, which require at least one of a Bluetooth host interfaces or an interfaces. When the Bluetooth slave interface and interface of the printer are active, the printer can preferably respond to printing data transceiving and instruction signals of the Bluetooth interface.

For example, an intelligent terminal device can discover and wake up the printer via Bluetooth, then send the printing data to the printer and start the printer to print on the print medium.

The printer can also be point-to-point connection with the intelligent devices through a WIFI interface. When the printer is in the standby status, it can accept the printing data through WIFI and start printing.

The printer can also automatically search and connect to a WIFI router, then the printer becomes a network printing device at this moment. Any intelligent device connected to the network can be connected to the printer, and then send the printing data to start printing.

The printing medium, according to different materials, can be paper, glossy photo paper, fiber fabric, clothing transfer medium, transparent adhesive paper, three-dimensional self-adhesive paper, plastic sheeting, or the like. The print medium is put on a horizontal plane, then the mobile type printer can be started to print the texts, patterns, graphics, and drawings required on the print media.

### Embodiment II

Compared with the first embodiment, the photoelectric distance sensor used in the present embodiment is a laser mouse sensor, a laser luminous tube is installed below the frame, a lens group 32 is installed below the laser tube, a receiving end of the laser mouse sensor is installed above the lens group to receive a reflected light, and a sensor signal accesses to a central processing unit.

### Embodiment III

Compared with embodiment I, an action wheel 2 is driven by a stepping motor 8 in the present embodiment, and the stepping motor can realize the positioning of the action wheel, without a distance sensor. Therefore, differing from the first embodiment, a photoelectric distance sensor is not required. A mobile printer is directly positioned through the rotation of the stepping motor.

### Embodiment IV

Compared with embodiment I, a rotary type position encoder 11 is used in place of a photoelectric mouse sensor to obtain the moving position of the printer in the present embodiment, and the rotary type position encoder and a rotation shaft of a motor 8 are installed coaxially.

### Embodiment V

Compared with embodiment IV, a rotary type position encoder 11 and a rotation shaft of an action wheel 2 are installed coaxially in the present embodiment.

### Embodiment VI

Compared with embodiment IV, a movable oscillating arm 12 is installed on racks at both sides of the action wheels through a pendulum shaft 14, a driven wheel 13 is installed at a terminal of the oscillating arm, and the rotary type position encoder and a rotation shaft of the driven wheel are installed coaxially.

1. A mobile type printer, comprising a rack, wherein the rack is equipped with a power source, a motor, a mobile device, an ink-jet printing head and a central processing unit, wherein the central processing unit comprises a mobile control unit and a printing control unit; the rack is moved as a whole by the mobile device to an appropriate place according to an instruction issued by the mobile control unit, ink-jet printing is conducted by the ink-jet printing head according to the instruction issued by the printing control unit; the mobile device comprises two coaxial action wheels connected with the motor and installed below a middle portion of the rack along a same rotation shaft in parallel; and the ink-jet printing head is arranged at one side of the rotation shaft, and the power source and the motor are arranged at the other side of the rotation shaft.

2. The mobile type printer according to claim 1, wherein the motor is a stepping motor.

3. The mobile type printer according to claim 1, wherein the mobile device further comprises a sensor group, parameters sensed are input by the sensor group into the central processing unit in real time; a rack moving path and an ink-jet position of the printing head are stored in the central processing unit; compared with the parameters input by the sensor group, when the rack is discovered to move to a preset position, the sensor group communicates with the printing control unit and issues issue an ink-jet printing instruction.

4. The mobile type printer according to claim 3, wherein the sensor group further comprises an angular velocity sensor and an acceleration sensor, when the rack moves, parameters detected by the angular velocity sensor and the acceleration sensor are input into the central processing unit, to enable the central processing unit to get hold of a moving posture of a printing device, and compared with a preset moving path, the action wheel is driven to rotate by a driving motor of the mobile control unit, to maintain the moving posture of the printer, so that the printer moves on the preset moving path.

5. The mobile type printer according to claim 3, wherein the sensor group comprises a photoelectric distance sensor.

6. The mobile type printer according to claim 5, wherein the photoelectric distance sensor is a photoelectric mouse sensor, a light emitting diode is installed below the rack, a lens group is installed below the light emitting diode, the photoelectric mouse sensor is installed above the lens group to receive a reflected light, and a sensor signal is accessed into the mobile control unit through an interface microprocessor.

7. The mobile type printer according to claim 5, wherein the photoelectric distance sensor is a laser mouse sensor, a luminous tube is installed below the rack, a lens group is installed below the luminous tube, the laser mouse sensor is installed above the lens group to receive a reflected light, and a sensor signal is accessed into the mobile control unit through an interface microprocessor.

8. The mobile type printer according to claim 3, wherein the sensor group comprises a rotary type position encoder, and the rotary type position encoder and the rotation shaft of the motor or the action wheel are coaxially installed.

9. The mobile type printer according to claim 3, wherein the sensor group comprises a rotary type position encoder, movable oscillating arms are installed in the racks at both sides of the action wheel through a pendulum shaft, a driven wheel is installed at a terminal of the movable oscillating arm, and the rotary type position encoder and the rotation shaft of the driven shaft are coaxially installed.

10. A printing method, comprising the following steps of: horizontally placing a medium to be printed, putting the mobile type printer according to claim 1 on the medium to be printed, presetting a plurality of information about rack moving path and ink-jet position of the printing head in the central processing unit of the mobile type printer according to requirements for printed contents, moving the printer by the mobile device on the medium to be printed according to the preset path, and printing by the printing head according to the preset ink-jet position.

11. The printing method according to claim 10, wherein, prior to starting printing, the mobile type printer is kept in a sloping status under the effect of gravity thereof, an outside of the rack and two action wheels are contacted with the medium to be printed in a manner of three-point contact; when starting printing, the mobile control unit drives the action wheels to rotate, so that the printer starts moving at a certain accelerated velocity in a direction along which the rack is not contacted with the medium, when a center of gravity of the printer is lower than an axis of the two action wheels, the outside of the rack automatically separates from the printing medium, to complete a starting process.

12. The printing method according to claim 10, wherein, prior to starting printing, the mobile type printer is kept in a sloping status under the effect of gravity thereof, an outside of the rack and two action wheels are contacted with the medium to be printed in a manner of three-point contact; when starting printing, the mobile control unit drives the action wheels to rotate, so that the printer starts moving at a certain accelerated velocity in a direction along which the rack is not contacted with the medium, when a center of gravity of the printer is higher than an axis of the two action wheels, the mobile control unit further needs to drive the action wheels to brake to slow down, so that the printer has a reverse accelerated velocity, and the outside of the rack automatically separates from the printing medium, to complete a starting process.
